(19) United States
(12) Patent Application Publication
(10) Pub. No.: US 2020/0318897 A1
(43) Pub. Date: Oct. 8, 2020

(54) CO2 Removal or Capture from CO2-rich Gas Mixtures

(71) Applicant: Jianguo XU, Wrightstown, PA (US)

(72) Inventor: Jianguo XU, Wrightstown, PA (US)

(21) Appl. No.: 16/755,431

(22) PCT Filed: Oct. 11, 2018
(86) PCT No.: PCT/US2018/055426

§ 371 Date: Apr. 10, 2020

Related U.S. Application Data
(60) Provisional application No. 62/570,976, filed on Oct. 11, 2017.

(51) Int. Cl. F25J 3/02; B01D 53/00; B01D 53/22; C10K 1/00; C10K 1/04; C10K 3/04

(52) U.S. Cl. CPC F25J 3/0266; B01D 2256/16; B01D 53/22; C10K 1/005; C10K 1/04; C10K 3/04; F25J 3/0252; F25J 2200/02; F25J 2200/70; F25J 2230/30; F25J 2240/90; F25J 2245/02; F25J 2270/02; F25J 2270/06; F25J 2270/12; F25J 2270/66; B01D 2257/504; B01D 53/002

(57) ABSTRACT

Processes for separating CO₂ from a gas mixture containing one or more of hydrogen, nitrogen, argon, CO, and methane or a combination thereof is described. The processes involve, for example, cooling and partial condensation of the gas mixture, preferably by a single loop refrigeration system with a mixed refrigerant, phase separation of the partially condensed stream, and distillation of the CO₂-rich liquid stream. At least a portion of the liquid CO₂ produced from the processes during the off-peak electricity demand hours can be stored and then heated, vaporized, further heated, and expanded for power generation during the peak electricity demand hours, helping balance the supply and demand of electricity of the electricity grid.

### BACKGROUND OF THE INVENTION

Coal, petrocoke, biomass, and other carbonaceous fuels are widely available and abundant energy resources with an existing infrastructure that produces a large proportion of the current CO₂ emissions. Recently proposed limits on CO₂ emissions from new electric generating units will require carbon capture on new coal (or another carbonaceous fuel)-fired power plant. Significant cost reduction of carbon capture is required to reduce the impact of carbon capture/sequestration on the cost of electricity, and therefore the living standard of our society. For coal-to-chemicals processes such as coal-to-methanol conversion processes and coal-to-liquid fuel processes, it is also desirable to further reduce the cost and energy consumption of CO₂ removal even before carbon sequestration becomes mandated.

The current state-of-the art technology for H₂S and CO₂ removal or capture from gases produced from gasifiers of carbonaceous fuels (e.g., after water-gas shift reaction to convert most CO into CO₂ and H₂ by reacting with water vapor) is physical absorption by dimethyl ethers of polyethylene glycol (DPEG) (Selexol), or methanol, N-Methyl-2-pyrrolidone (NMP), propylene carbonante, and sulfinol. While regulations on commercial scale CO₂ capture for sequestration from such sources are still evolving, rejection of a large portion of the CO₂ from coalgas is a critical step in the commercial scale coal-to-chemicals, coal-to-liquid fuel, and even coal-to-synthetic natural gas plants. CO₂ removal is the most energy and capital intensive of all separation/removal processes from such a gas mixture, including those for mercury removal, sulfur removal, and moisture removal. To the inventor's knowledge, no other processes have been commercialized for large scale removal or capture of CO₂ from gasifiers of carbonaceous fuels.

Consonni et al (Consonni, S., Vigano, F., Kreutz, T, and De Lorenzo, L.; “CO₂ CAPTURE IN IGCC PLANTS VIA CRYOGENIC SEPARATION”, Sixth Annual Conference on Carbon Capture & Sequestration, Pittsburgh, 2007) reported a partial condensation-based process with a sulfur and water-free coal gas that consumes about 32% less power than a Selexol-only process. However, a significant amount of fuel is lost to the captured CO₂ in that process, resulting in a significant loss of heating value of the fuel, and at the same time making the produced CO₂ unfit for safe storage due to the high CO content. Therefore, such a partial condensation-based process cannot be implemented without major improvements to resolve the fuel loss/high CO content-in-CO₂ issue. Besides, the process of Consonni et al uses a multistage ammonia refrigeration system, which is capital intensive and not efficient, and can be unsafe. For example, an operating pressure as low as 0.22 bara is required to provide the level of refrigeration needed for 90% CO₂ capture, which may require very large refrigerant compressor size and can potentially form explosive air-ammonia mixtures inside the refrigerant loop if there are leaks in the sub-ambient pressure section of the refrigerant loop. Additionally, the enthalpy-temperature (H-T) curves of the refrigerants and the process streams to be cooled do not match well. The temperature of the refrigerant is basically the same throughout each of such heat exchangers while that of the process stream decreases as it is cooled, such that in each heat exchanger involving evaporation of the refrigerant, the colder process stream end ΔT is pinched while the warmer process stream end ΔT is widely open, resulting in large losses of thermal exergy in the warmer process stream section. These losses eventually lead to increased compression cost of the refrigeration system.

To mitigate the fuel loss and CO emission issues, Keller (Keller, A., “CARBON DIOXIDE CAPTURE AND LIQUEFACTION”, U.S. Pat. No. 8,585,802) combined partial condensation with an absorption, or adsorption, or freezing for a more complete capture of CO₂, followed by purifying the combined crude liquid CO₂ streams from both partial condensation and the subsequent separation unit to reduce the CO content in the CO₂ to below 1000 ppm or 200 ppm levels as needed. According to Keller, large power savings over the conventional technology could be achieved under certain power numbers and machinery efficiency assumptions. However, Keller's processes are rather complex, requiring a high capital cost than a simpler process. Additionally, Keller's processes contain many irreversible steps. For example, the refrigeration cascades are not only capital intensive due to the need for compressors for the various refrigerants and added heat exchangers, but also rather inefficient. Similar to the refrigeration system used by Consonni et al, the enthalpy-temperature (H-T) curves of the refrigerants and the streams to be cooled do not match well, such that in each refrigerated heat exchanger, the cold process stream end ΔT is pinched while the warm process stream end ΔT is wide-open, resulting in large losses of thermal exergy at the warm process stream end/sections of the heat exchangers. Pressure reduction of the rich liquid coming out of the absorber and/or those during pressure equalization provide-purge, and counter-current blowdown steps of an adsorption process are also highly irreversible, causing significant efficiency losses and the need for a recycle compressor. Similar is true of the pressure reduction of the various refrigerants used in Keller's processes, as well as mixing of streams with different temperatures. Furthermore, absorption, adsorption, and freezing have their own disadvantages. For example, in temperature swing adsorption and absorption separation processes, introduction of an additional material (adsorbent and absorbent) causes parasitic losses in heat transfer. Also, in pressure swing adsorption processes, large pressure drop losses occur during the pressure equalization and blowdown processes, and expensive compressors are often needed, while in freezing separation processes, solid handling often results in complex and expensive equipment and highly irreversible processes.

As a consequence, partial condensation-based processes for CO₂ removal or capture have not been implemented in commercial purification plants despite the fact that many coal-to-methanol, coal-to-liquids, and other carbonaceous material gasification-purification process plants have been built in the last decades. There is a need for a more efficient and simpler process to reduce the cost of CO₂ rejection or capture from coal gasifier gas or mixtures of CO₂ with lower boiling components such as hydrogen, helium, nitrogen, CO, and methane.

In addition, the supply- and demand of electricity of the electricity grid normally experience cycles. A grid that can handle the peak electricity demand requires additional investment in electrical power generation. The power generator for supplying the peak power is typically a low efficiency gas turbine whose thermal efficiency is only about half of the base-line power generation systems that run all the time. It is desirable to reduce the difference between the peak electricity demand and off-peak electricity demand.

### BRIEF SUMMARY OF THE INVENTION

In one general aspect, the invention relates to process for separating CO₂ from a mixture comprising CO₂ and at least one component selected from the group consisting of hydrogen, nitrogen, argon, CO, and methane, or a combination thereof, wherein the mixture has a pressure of greater than 10 bar, preferably 60 bar to 300 bar, the process comprising:

1) cooling the mixture to obtain a partially condensed stream,

2) feeding the partially condensed stream into a phase separator to produce a CO₂-depleted gas stream and a CO₂-rich liquid stream,

3) splitting the CO₂-rich liquid stream from the phase separator into at least two liquid substreams,

4) heating at least one of the liquid substreams to thereby form at least one two-phase substream, and

5) feeding the at least one two-phase substream and the remaining liquid substream(s) into a distillation column to produce a liquid comprising substantially CO₂ and an overhead vapor comprising substantially the at least one component, wherein the substream with a higher temperature is fed to a lower location of the distillation column than that of the substream with a lower temperature.

In another general aspect, the invention relates to a process for separating CO₂ from a mixture comprising CO₂ and at least one component selected from a group consisting of hydrogen, nitrogen, argon, CO, and methane, or a combination thereof, wherein the mixture has a pressure of greater than 10 bar, preferably 60 bar to 300 bar, the process comprising:

1) cooling the mixture by a single loop refrigeration system with a mixed refrigerant to obtain a partially condensed stream,

2) feeding the partially condensed stream into a phase separator to produce a CO₂-depleted gas stream and a CO₂-rich liquid stream, and

3) feeding the CO₂-rich liquid stream into a distillation column to produce a liquid comprising substantially CO₂ and an overhead vapor comprising substantially the at least one component.

In yet another general aspect, the invention relates to a process for separating CO₂ from a mixture comprising CO₂ and at least one of the components selected from a group consisting of hydrogen, nitrogen, argon, CO, methane, or a combination thereof, wherein the mixture has a pressure of greater than 10 bar, preferably 60 bar to 300 bar, the process comprising:

1) cooling the mixture to obtain a partially condensed stream,

2) feeding the partially condensed stream into a phase separator to produce a CO₂-depleted gas stream and a CO₂-rich liquid stream,

3) feeding the CO₂-rich liquid stream into a distillation column to produce an overhead vapor stream and a liquid comprising substantially CO₂,

4) heating and vaporizing the liquid comprising substantially CO₂ to obtain a heated and vaporized CO₂ gas,

5) further heating the heated and vaporized CO₂ gas to obtain a superheated CO₂ gas, and

6) expanding the superheated CO₂ in an expander for power generation.

An overhead vapor, such as that from a distillation column, partial condensation vapor from the distillation column, or Dephlegmator, as well as the vapor from partial condensation of the mixture coming out of the phase separator, can be heated and expanded for power generation. A liquid comprising substantially CO₂ from the distillation column can also be heated and/or vaporized, further heated, and expanded for power generation. The heating/vaporization, further heating and expansion of the liquid can be periodical. At least a portion of the liquid CO₂ produced during the off-peak electricity demand hours can be stored and then heated, vaporized, further heated, and then expanded for power generation during the peak electricity demand hours, along with the overhead vapor (such as CO₂-depleted gas stream) and/or the liquid CO₂ produced during the peak electricity demand hours. This is to help balance the supply and demand of electricity of the electricity grid.

### BRIEF DESCRIPTION OF THE DRAWINGS

The foregoing summary, as well as the following detailed description of the invention, will be better understood when read in conjunction with the appended drawings. It should be understood that the invention is not limited to the precise embodiments shown in the drawings.

In the drawings:

FIG. 1 is the process flow diagram for the coal-gas CO₂ capture process described in Example 1;

FIG. 2 is the process flow diagram for the coal-gas CO₂ removal process for methanol synthesis described in Example 2;

FIG. 3 is the enthalpy-temperature plot of Econonizer ECO;

FIG. 4 is the enthalpy-temperature plot of Econonizer ECO₂; and

FIG. 5 is the process schematic for the process that uses a membrane separator to reduce the hydrogen from the gas mixture containing CO₂ and H₂ before feeding the H₂-depleted gas mixture to a CO₂ separation process according to an embodiment of the application.

### DETAILED DESCRIPTION OF THE INVENTION

Various publications, articles and patents are cited or described in the background and throughout the specification; each of these references is herein incorporated by reference in its entirety. Discussion of documents, acts, materials, devices, articles or the like which has been included in the present specification is for the purpose of providing context for the invention. Such discussion is not an admission that any or all of these matters form part of the prior art with respect to any inventions disclosed or claimed.

Unless defined otherwise, all technical and scientific terms used herein have the same meaning as commonly understood to one of ordinary skill in the art to which this invention pertains. Otherwise, certain terms used herein have the meanings as set forth in the specification. All patents, published patent applications and publications cited herein are incorporated by reference as if set forth fully herein.

It must be noted that as used herein and in the appended claims, the singular forms “a,” “an,” and “the” include plural reference unless the context clearly dictates otherwise.

Unless otherwise indicated, the term “at least” preceding a series of elements is to be understood to refer to every element in the series. Those skilled in the art will recognize, or be able to ascertain using no more than routine experimentation, many equivalents to the specific embodiments of the invention described herein. Such equivalents are intended to be encompassed by the invention.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integer or step. When used herein the term “comprising” can be substituted with the term “containing” or “including” or sometimes when used herein with the term “having”.

When used herein “consisting of” excludes any element, step, or ingredient not specified in the claim element. When used herein, “consisting essentially of” does not exclude materials or steps that do not materially affect the basic and novel characteristics of the claim. Any of the aforementioned terms of “comprising”, “containing”, “including”, and “having”, whenever used herein in the context of an aspect or embodiment of the invention can be replaced with the term “consisting of” or “consisting essentially of” to vary scopes of the disclosure.

As used herein, the conjunctive term “and/or” between multiple recited elements is understood as encompassing both individual and combined options. For instance, where two elements are conjoined by “and/or”, a first option refers to the applicability of the first element without the second. A second option refers to the applicability of the second element without the first. A third option refers to the applicability of the first and second elements together. Any one of these options is understood to fall within the meaning, and therefore satisfy the requirement of the term “and/or” as used herein. Concurrent applicability of more than one of the options is also understood to fall within the meaning, and therefore satisfy the requirement of the term “and/or.”

As used herein, the term “subcool” means “further cool” a fluid that is completely condensed. The term “external coolant” refers to one or more coolants that are not a part of the refrigerant. Any suitable external coolant can be used in the present invention. Examples of external coolant include, but are not limited to, cooling water, air, a process stream to be heated, such as liquid CO₂ to be heated and vaporized for expansion.

As used herein, “peak electricity demand hours” refers to hours during which the demand for electricity is higher than the average demand. As used herein “off-peak electricity demand hours” refers to hours during which the demand for electricity is lower than the average demand.

According to embodiments of the application, CO₂ can be separated (e.g., captured or removed) from a mixture comprising CO₂ and at least one other component, such as components with lower boiling points than that of CO₂, including but not limited to hydrogen, nitrogen, argon, CO, and methane, or a combination thereof. Preferably, the mixture is obtained from gasification of a carbonaceous material.

As used herein, “gasification of a carbonaceous material” refers to a process in which oxygen, water (or its vapor form, steam) and the carbonaceous material react to form CO, CO₂, and H₂. Because the oxygen feed can contain some argon, the carbonaceous material can also contain some nitrogen and sulfur. The gas mixture obtained from gasification of a carbonaceous material can also contain some nitrogen, argon, and very small amount of sulfur compounds such as H₂S and COS as well. Preferably, the very small amounts of sulfur compounds is removed. Some small amount of methane can also form in the process. In a gas mixture from gasification of a carbonaceous material, the CO content is high. Therefore, this gas mixture normally goes through a water-gas shift reactor to react with more steam to convert much of the CO to form CO₂ and H₂. The gas mixture is then further dried to remove essentially all the water content before it is cooled and partially condensed using a process according to embodiments of the invention.

According to embodiments of the invention, a gas mixture comprising CO₂ and at least one other component, such as hydrogen, nitrogen, argon, CO, methane, or a combination thereof (which is also herein referred to as the “feed” or “feed gas”), is cooled to obtain a partially condensed stream, the partially condensed stream is fed into a phase separator to produce a CO₂-depleted gas stream and a CO₂-rich liquid stream, and the CO₂-rich liquid stream is further separated by a distillation column (also called “stripping column” herein) to produce a liquid comprising substantially CO₂ and an overhead CO₂-depleted vapor. The overhead vapor can be cooled and fed into a partial condensation unit such as a Dephlegmator for further separation. To avoid CO₂ frosting and clogging of the distillation column but minimize the amount of CO₂ in the overhead vapor, the liquid stream to be fed into the distillation column has a temperature higher, preferably less than 15 K higher, than the CO₂ freeze out temperature. For example, the liquid stream to be fed into the distillation column can have a temperature that is 14, 13, 12, 11, 10, 9, 8, 7, 6, 5, 4, 3, 2 or 1 K higher than the CO₂ freeze out temperature. The freezing temperature of CO₂ in 10 bar to 300 bar range is close to its triple point temperature, which is about 217 K.

In preferred embodiment, the gas mixture comprising CO₂ is cooled by a single loop refrigeration system with a mixed refrigerant using a refrigeration process according to embodiments of the application. As used herein, a “single loop refrigeration system” refers to a refrigeration system in which a refrigeration is compressed, cooled and condensed, reduced in pressure, and heated and completely vaporized to complete a cycle in which substantially all the refrigerant is returned for compression at a single pressure and discharged from the compressor for cooling and condensation at a single pressure. In contrast, a multiple loop refrigeration system is one in which the liquid refrigerant is separated into two or more substreams, reduced to different pressures and heated and vaporized in separate passages, and then fed to the suction points of different stages of the compressor or different compressors.

As used herein, a “mixed refrigerant” refers to a refrigerant containing a mixture of two or more components whose boiling points are different from each other. The mixed refrigerant condenses in a range of temperatures and vaporizes in a different range of temperatures. Preferably, a mixed refrigerant contains at least one of ethane and ethylene (C2 component) and one of butenes and butanes. More preferably, the non-C2 components of the mixed refrigerant is from a single source, such as a commodity, such as liquid petroleum gas (LPG) (i.e., commercial propane) or industrial butane, which can contain other components. In comparison, a mixture of two or more commodities would require additional on-site storage tanks. Using a mixed refrigerant whose non-C2 components are from a single source allows the refrigerant storage system to be simpler and cheaper to install and maintain.

In another embodiment, a mixed refrigerant contains at least one lower boiling component, such as methane, ethane, ethylene, CO₂, fluoromethane, difluoromethane, and at least one component whose boiling point is higher than the lower boiling component, such as hydrocarbons with three to six carbon atoms, dimethyl ether, hydrofluorocarbons with one to three carbon atoms such as 1,1,1,2-Tetrafluoroethane (HFC-134a) and 2,3,3,3-Tetrafluoropropene (HFO1234yf). The preferred refrigerant contains 20-50 (mol) % hydrocarbon(s) with two carbons and 50-80% hydrocarbon(s) with four carbons.

In one embodiment of the application, at least a portion of the overhead vapor of the distillation column first fed to a Dephlegmater. A Dephlegmater is a separation device in which a vapor mixture is fed to the bottom of the device and simultaneously cooled and partially condensed as it travels upwards inside the device due to simultaneous heat removal from the device, while the liquid, which is richer in the heavier (i.e., higher boiling component(s)) than the vapor from which it is condensed, formed in the device is allowed to flow downwards, mix with the warmer liquid formed at the lower positions as it flows downwards, and exits from the bottom of the device to accomplish vapor-liquid equilibrium-based separation. Note some of the liquid flowing downwards evaporates due to the higher temperature at the lower location so that the liquid exiting the Dephlegmater is enriched in the heavier component(s). The bottoms liquid from the Dephlegmator is fed to the top of the distillation column for further separation. Doing so allows more CO₂ to be captured.

According to embodiments of the application, a recycle compressor can be used to recycle the feed gas if the pressure of the destination of the recycle gas is higher than that of the stripping column. However, it is possible, and indeed desirable, to set the pressure of the stripping column high enough so that the recycle gas can flow to the recycle destination without needing a compressor, and ideally without needing a throttle valve with a large pressure drop as well.

### Embodiments

The invention provides also the following non-limiting embodiments.

Embodiment 1 is a process for separating CO₂ from a mixture comprising CO₂ and at least one component selected from the group consisting of hydrogen, nitrogen, argon, CO, and methane, or a combination thereof. The mixture has a pressure of greater than 10 bar, preferably 60 bar to 300 bar, such as 60 bar, 120, 180, 240 or 300 bar. The process comprises: 1) cooling the mixture to obtain a partially condensed stream, 2) feeding the partially condensed stream into a phase separator to produce a CO₂-depleted gas stream and a CO₂-rich liquid stream, 3) splitting the CO₂-rich liquid stream from the phase separator into at least two liquid substreams, 4) heating at least one of the liquid substreams to thereby form at least one two-phase substream, and 5) feeding the at least one two-phase substream and the remaining liquid substream(s) into a distillation column (which also referred to herein as stripping column) to produce a liquid comprising substantially CO₂ and an overhead vapor comprising substantially the at least one non-CO₂ component, wherein the substream with a higher temperature is fed to a lower location of the distillation column than that of the substream with a lower temperature.

Embodiment 2 is the process of embodiment 1, wherein the mixture comprises CO₂, hydrogen, CO, and small amounts of inert gas components, such as nitrogen and argon, preferably, the mixture is obtained from gasification of a carbonaceous material, more preferably, the mixture does not contain water or a sulfur compound.

Embodiment 3 is the process of embodiment 1 or 2, wherein the overhead vapor from the stripping column is further cooled to a temperature within 15 K of but above the CO₂ freezeout temperature of the mixture and partially condensed to produce a vapor and a liquid and the resultant liquid is sent back to the top of the stripping column.

Embodiment 4 is the process of any one of embodiments 1 to 3, wherein at least a portion of the overhead vapor from the stripping column is fed to a Dephlegmator to produce a vapor from the top and a liquid from the bottom, and at least a portion of the liquid from the bottom of the Dephlegmator is fed to the top of the stripping column.

Embodiment 5 process of any one of claims 1 to 4, wherein a single loop refrigeration system with a mixed refrigerant is used to provide at least a portion of refrigeration for the cooling of step (1), and wherein at least a portion of the liquid from the distillation column is heated, vaporized, further heated, and expanded for power generation.

Embodiment 6 is a process for separating CO₂ from a mixture comprising CO₂ and at least one of the components selected from a group consisting of hydrogen, nitrogen, argon, CO, methane, or a combination thereof, wherein the mixture having at a pressure of greater than 10 bar, preferably 60 bar-300 bar, such as 60 bar, 120, 180, 240 or 300 bar, the process comprising: 1) cooling the mixture by a single loop refrigeration system with a mixed refrigerant to obtain a partially condensed stream, 2) feeding the partially condensed stream into a phase separator to produce a CO₂-depleted gas stream and a CO₂-rich liquid stream, and 3) feeding the CO₂-rich liquid stream into a distillation column to produce a liquid comprising substantially CO₂ and an overhead vapor comprising substantially the at least one non-CO₂ component.

Embodiment 7 is the process of embodiment 5 or 6, wherein in step (1), the mixture is cooled by the single loop refrigeration system with the mixed refrigerant using a refrigeration process comprising: a) compressing a vapor refrigerant comprising two or more components in a refrigerant compressor to obtain a compressed refrigerant, b) cooling the compressed refrigerant by an external coolant to obtain a partially condensed refrigerant, c) further cooling, condensing, and subcooling the partially condensed refrigerant in a heat exchanger to obtain a subcooled refrigerant, d) reducing the pressure of the subcooled refrigerant to obtain a reduced pressure refrigerant, e) heating and vaporizing the reduced pressure refrigerant in the heat exchanger of step (c) to obtain the vapor refrigerant and to provide refrigeration for the cooling of the mixture and the cooling, condensing, and subcooling of the partially condensed refrigerant, and f) feeding the vapor refrigerant to the refrigerant compressor, thereby completing the cycle; preferably the temperature of the reduced pressure refrigerant from step (d) is 10K or less, such as 10, 9, 8, 7, 6, 5, 4, 3, 2 or 1K, lower than the temperature of the subcooled refrigerant from step (c).

Embodiment 7a is the process of the embodiment 5 or 6, wherein a) the mixed refrigerant refrigeration process comprising 1) compressing a vapor refrigerant in a refrigerant compressor, 2) cooling and partially condensing the compressed refrigerant by an external coolant, 3) further cooling, condensing, and subcooling the partially condensed refrigerant in a heat exchanger by the vaporizing refrigerant of the same components at step 5), 4) reducing the pressure of the subcooled refrigerant from step 3), and 5) heating and vaporizing the reduced pressure refrigerant from step 4) in the heat exchanger to provide the refrigeration for cooling and partially condensing the CO₂-containing feed gas mixture and cooling and condensing, as well as subcooling the said partially condensed refrigerant in step 3), 6) feeding the resultant vapor refrigerant from step 5) to the refrigerant compressor, thereby completing the cycle; b) the state of the refrigerant after cooling in step 3) is such that after pressure reduction in step 4), the temperature of the refrigerant is lower than but within 10 K, such as 10, 9, 8, 7, 6, 5, 4, 3, 2 or 1K, of the temperature of the liquid refrigerant right before pressure reduction.

Embodiment 8 is the process of Embodiment 7, wherein the refrigerant compressor is a multi-stage compressor with a compression ratio in the last stage of greater than 2.

Embodiment 9 is the process of Embodiment 8, further comprising applying compression heat generated in the last stage of the refrigerant compressor to the CO₂-depleted gas stream and expanding the heated CO₂-depleted gas stream in an expander.

Embodiment 10 is the process of any one of Embodiments 5 to 9, wherein the mixed refrigerant comprises at least one lower boiling component, such as methane, ethane, ethylene, CO₂, fluoromethane, difluoromethane, and at least one component whose boiling point is higher than the lower boiling component, such as hydrocarbons with three to six carbon atoms, dimethyl ether, hydrofluorocarbons with one to three carbon atoms such as 1,1,1,2-Tetrafluoroethane (HFC-134a) and 2,3,3,3-Tetrafluoropropene (HFO1234yf).

Embodiment 10a is the process of Embodiment 10, wherein the mixed refrigerant comprises at least one of ethane and ethylene, and at least one of propylene, propane, butanes and butenes.

Embodiment 10b is the process of Embodiment 10 or 10a, wherein the mixed refrigerant contains 20-50 (mol) % hydrocarbon(s) with two carbons and 50-80% hydrocarbon(s) with four carbons.

Embodiment 11 is the process of any one of embodiments 5 to 10b, wherein the mixed refrigerant comprises non-C₂ components from a single source, preferably industrial liquefied petroleum gas (LPG) or industrial butanes.

Embodiment 12 is the process of any one of embodiments 1 to 11, further comprising vaporizing at two or more pressures the liquid comprising substantially CO₂ to thereby provide at least a portion of the refrigeration for the cooling and partial condensation of the mixture.

Embodiment 13 is the process of embodiment 12, wherein the pressure of the distillation column is lower than the pressure of the CO₂-rich liquid stream coming out of the phase separator, and the liquid substream to be heated to a higher temperature is let down in pressure to a level higher than that of the distillation column before it is heated.

Embodiment 14 is the process of any one of embodiments 1 to 13, wherein at least a portion of the CO₂-depleted gas stream from the phase separator, after being heated, is expanded to a lower pressure to generate work, optionally also provides refrigeration for the cooling and partial condensation of the mixture.

Embodiment 15 is the process of any one of embodiments 1 to 14, wherein the compression heat of the last stage of the refrigerant compressor is used to heat the CO₂-depleted gas stream going into the downstream process wherein the thus heated CO₂-depleted gas is expanded in an expander.

Embodiment 16 is a process for separating CO₂ from a mixture comprising CO₂ and at least one of the components selected from a group consisting of hydrogen, nitrogen, argon, CO, and methane, or a combination thereof, wherein the mixture having at a pressure of greater than 10 bar, preferably 60 bar-300 bar, the process comprising 1) cooling the mixture to obtain a partially condensed stream, 2) feeding the partially condensed stream into a phase separator to an overhead vapor and a substantially CO₂ liquid, and further comprising i) heating and vaporizing the substantially CO₂ liquid from the bottom of the stripping column, ii) further heating the resultant heated and vaporized CO₂, and iii) expanding the resultant CO₂ gas from step ii) in an expander for power generation.

Embodiment 17 is the process of embodiment 16, wherein expanders and a stage of the booster compressor of the feed gas are preferably mechanically connected to form a compander.

Embodiment 18 is a process for separating CO₂ from a mixture comprising CO₂ and at least one of the components selected from a group consisting of hydrogen, nitrogen, argon, CO, methane, or a combination thereof, wherein the mixture has a pressure of greater than 10 bar, preferably 60 bar to 300 bar, the process comprising: 1) cooling the mixture to obtain a partially condensed stream, 2) feeding the partially condensed stream into a phase separator to produce a CO₂-depleted gas stream and a CO₂-rich liquid stream, 3) feeding the CO₂-rich liquid stream into a distillation column to produce an overhead vapor and a liquid comprising substantially CO₂, 4) heating and vaporizing the liquid comprising substantially CO₂ to obtain a heated and vaporized CO₂ gas, 5) further heating the heated and vaporized CO₂ gas to obtain a superheated CO₂ gas, and 6) expanding the superheated CO₂ in an expander for power generation. Superheating of the vaporized CO₂ is needed since if a saturated vapor is expanded, a large portion of the gas may become liquid which may hurt the expander. Therefore, the gas going into the expander must be further heated after it is vaporized.

Embodiment 19 is the process of any one of embodiments 1 to 18, wherein during off-peak electricity demand hours, at least a portion of the liquid comprising substantially CO₂ from the distillation column is stored, while during peak electricity demand hours, the stored and instantaneously generated liquid comprising substantially CO₂ are heated, vaporized, further heated, and expanded in an expander for power generation.

Embodiment 20 is the process of embodiment 19, wherein the liquid comprising substantially CO₂ is vaporized and/or further heated by exhaust gas of a gas turbine and/or the effluent of a water-gas shift reactor.

Embodiment 21 is the process of any one of embodiments 1 to 20, further comprising applying a gas mixture to a membrane separator to obtain the mixture comprising CO₂ and the at least one component, prior to step (1), wherein the membrane separator comprises a membrane selectively permeable to hydrogen but is much less or non-permeable to CO₂.

Embodiment 21a is the process of any one of embodiment 1 to 20, wherein 1) the feed gas is obtained from a membrane separator wherein the gas fed to the membrane separator contains hydrogen and CO₂, and may also contain such gases as CO, N₂, and Ar, and 2) a portion of the hydrogen in the feed is removed by permeating through a membrane selectively permeable to hydrogen while the remaining gas, including substantially all the CO₂, the remaining hydrogen that has not permeated through the membrane, and the other remaining gas components, form the feed gas to the process. Any suitable membrane separator can be used in embodiment 21 or 21a in view of the present disclosure. As known to those skilled in the art, the pressure of the hydrogen from the membrane separator is significantly lower than the pressure of the remaining gas that is the feed gas (the “mixture”) to a process according to an embodiment of the invention.

Embodiment 22 is the process of any one of claims 1 to 21a, further comprising obtaining the mixture from gasification of a carbonaceous material, heating at least a portion of the vapor from the distillation column or partial condensation downstream of the distillation column, or Dephlegmator, mixing the heated vapor with the mixture obtained from the gasification of the carbonaceous material in a water-gas shift reactor to convert some of the CO into H₂ and CO₂ in a reactor effluent, cooling the reactor effluent to obtain a cooled effluent, then drying the cooled effluent to obtain the mixture for the cooling in step (1).

Embodiment 22a the process of embodiment 1 to 21a, wherein the feed gas mixture is obtained from gasification of a carbonaceous material wherein at least a portion of the vapor from distillation column or partial condensation downstream of the distillation column, or Dephlegmatoris heated and then mixed with the CO₂-containing feed gas mixture from gasification of a carbonaceous material first reacts with steam in a water-gas shift reactor to convert some of the CO into H₂ and CO₂, the reactor effluent is cooled, and then dried before being further cooled and partially condensed.

Embodiment 23 is the process of any embodiment of the application where a single loop refrigeration system with a mixed refrigerant is used to provide at least a portion of refrigeration needed for cooling and partially condensing the feed mixture and wherein at least a portion of the liquid CO₂ from the distillation column is heated, vaporized, further heated, and expanded for power generation.

Embodiment 24 is the process of embodiment 23, wherein a single loop refrigeration system with a mixed refrigerant is used to provide at least a portion of refrigeration needed for cooling and partially condensing the feed mixture and wherein at least a portion of the liquid CO₂ is stored during off-peak electricity demand hours, while during the peak electricity demand hours, the stored as well as the liquid CO₂ directly produced from the distillation column are heated, vaporized, further heated, and expanded for power generation.

Embodiment 25 is the process of any one of embodiments 1 to 24, wherein the overhead vapor stream from the distillation column is heated and recycled, preferably, to the entrance of the water-gas shift reactor.

Embodiment 26 the process of any one of embodiments 1 to 24, wherein the overhead vapor stream from the distillation column is heated and recycled, to the mixture to be cooled and partially condensed in step 1)

Embodiment 26 is a system for conducting any one of the process of Embodiments 1 to 26.

The following examples of the invention are to further illustrate the nature of the invention. It should be understood that the following examples do not limit the invention and the scope of the invention is to be determined by the appended claims.

### Example 1: CO₂ Capture from Coal Gas for Power Generation

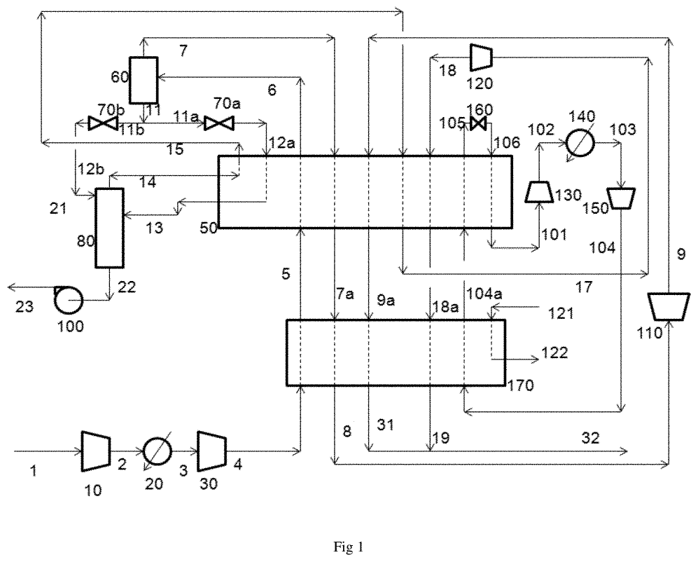

FIG. 1 illustrates an example of a process following the teaching of the present application with a feed gas containing CO₂, hydrogen, CO, and likely some smaller amounts of other gas components such as methane, argon, and nitrogen, such as that from a coal gasifier after water-gas shift reaction and sulfur and moisture removal. In the process, the feed gas, in line 1, is boosted in pressure (e.g. from about 60 bar) to a higher level such as 180 bar by the booster compressor stages 10 and 30 (with an intercooler 20). The pressure boosted feed gas, in line 4, is then fed to the higher temperature heat exchanger 170 and the main heat exchanger 50, where it is cooled to a temperature that is somewhat higher than the freezing temperature of CO₂, which is about 216.6 K.

Much of the CO₂ in the feed gas is condensed as it exits the cold end of the main heat exchanger, 50. The resultant two phase stream, in line 6, is fed to the main phase separator, 60. The vapor phase from the main phase separator, in line 7, is heated in the main heat exchanger 50 to recover its refrigeration, and then heated further in the higher temperature exchanger, 170, and then fed to the main expander, 110, producing mechanical work and a colder gas stream, in line 9, which is again heated in the main heat exchanger 50 and then the higher temperature exchanger 170. The resulting CO₂-depleted stream, in line 31, mixes with the minor CO₂-depleted stream, in line 19, and sent to the power generation unit.

The liquid stream from the main phase separator 60, in line 11, which is also called crude liquid CO₂, is split into the crude liquid CO₂ to be heated, in line 11a, and a second crude liquid CO₂, in line 11b. Each of the crude liquid CO₂ streams is let down in pressure through a valve, 70a and 70b respectively, to a pressure lower than the critical pressure of CO₂, but high enough to overcome the flow resistance (including that due to elevation change) for them to flow into the stripping column. The resultant first two-phase stream, in line 12a, is heated and further partially vaporized in the main heat exchanger 50 to recover some of the refrigeration before it is taken out of the main heat exchanger 50 and fed to the stripping column 80 at an intermediate position for removing essentially all of the light components from the liquid CO₂ by distillation, thereby making the CO₂ for storage satisfy the regulation on CO content and recover the other components for use in the downstream process. The second two-phase stream, in line 12b, is directly fed to the top of the stripping column 80. The overhead vapor of the stripping column, in line 14, is fed to an intermediate location of the main heat exchanger 50, and cooled and partially condensed, ideally within 15 K of but still higher than the freezing temperature of CO₂, which is about 217 K. The section of heat exchanger between streams 14 and 15 is preferably a Dephlegmator—it allows vapor to go up and liquid to flow downwards so that heat transfer and vapor-liquid equilibrium-based separation take place simultaneously. That is why the arrows on stream 14 go both ways: vapor flows up (arrow points towards right) and liquid flows down and back to the column (arrow points to the left). The remaining vapor exiting from the top of the Dephlegmator, in line 15, is taken out of the main heat exchanger. The bottoms liquid of the stripping column 80, in line 22, is boosted in pressure to 150 bar (or whatever CO₂ delivery pressure has to be) by pump 100 and resultant high pressure CO₂, in line 23, is sent to storage, ideally in a mature oil reservoir for enhanced oil recovery. As can be seen the Dephlegmator is an integral part of the main heat exchanger 50 in this case.

Note the “vapor” from partial condensation or Dephlegmator is sometimes called “gas” elsewhere since most of the components are far above their condensation temperature. However, since such a gas stream is saturated with one or more higher boiling component(s) which can dense upon further cooling, “vapor” is used instead of “gas” in this document.

The remaining vapor exiting from the top of the Dephlegmater, in line 15, is heated in the main heat exchanger, 50, and the heated vapor, in line 17, and then fed to the minor expander, 120. The resultant cold CO₂-depleted gas from the minor expander 120, in line 18, is heated in the main heat exchanger, 50, and then in the higher temperature exchanger 170. The resulting heated minor CO₂-depleted gas stream, in line 19, is mixed with the main CO₂-depleted gas stream, in line 31, to form a CO₂-depleted gas, in line 32, to be fed to the down-stream process. The downstream process may or may not include another separation process that separate CO₂ and/or CO from hydrogen.

Alternatively, instead of going to the minor expander 120, stream 17 can be compressed and recycled to become a part of the feed stream 4, either using a separator compressor for its compression or mixing with stream 3 and using Compressor 30 for this purpose. This would allow for a somewhat higher CO₂ recovery. A third approach would be recycling stream 17, after its compression, further back to the water-gas shift reactor to convert much of the CO with stream into H₂ and CO₂ to further improve the CO2 capture rate. This part is not shown in FIG. 1.

The mixed refrigerant, preferably contains at least one of ethane and ethylene and one of butenes and butanes, the latter of which is preferably from a single source such as an industrial butane product, which contains isomers of butane and small amounts of propane and pentanes), coming back from the main heat exchanger, in line 101, is fed to the first stage of the refrigerant compressor, 130, cooled in the intercooler, 140, and further compressed in the second stage of the refrigerant compressor, 150, which has a compression ratio of greater than 2. The use of a higher pressure ratio in the second compression stage avoids the need to handle a two phase stream at the suction of a compressor stage, reduces the number of compressor stages, and allows more compression heat to be recovered by the CO₂-depleted gas stream before it is sent to the power generation unit. The resultant high pressure and hot refrigerant is cooled and at least partially condensed in the higher temperature exchanger, 170, and then further cooled (fully condensed if it is not fully condensed in the higher temperature exchanger, and then subcooled) in the main heat exchanger 50. The resultant subcooled refrigerant stream, in line 105, is let down in pressure in the throttle valve, 160, resulting in a lower pressure, mainly liquid stream (at a vapor fraction of less than 3%, e.g., 1.5%), in line 106, that is only a few K colder than the liquid stream before pressure reduction, in line 105—this is accomplished by choosing an appropriate composition of the mixed refrigerant and using the right pressures before and after the throttle valve, 160. The resultant stream with a small vapor fraction, in line 106, is heated and vaporized in the main heat exchanger to provide refrigeration. The return lower pressure vapor refrigerant, in line 101, is compressed in the first stage of the refrigerant compressor 130, thereby completing the refrigeration cycle.

The mixed refrigerant contains at least one lower boiling component selected from methane, ethane, ethylene, CO₂, fluoromethane, and difluoromethane, and at least one component whose boiling point is higher than the lower boiling component, selected from hydrocarbons with three to six carbon atoms, dimethyl ether, hydrofluorocarbons with one to three carbon atoms such as 1,1,1,2-Tetrafluoroethane (HFC-134a) and 2,3,3,3-Tetrafluoropropene (HFO1234yf). The preferred refrigerant contains 20-50 (mol) % hydrocarbon(s) with two carbons and 50-80% hydrocarbon(s) with four carbons.

Some cooling water, in line 121, is needed for cooling in the higher temperature exchanger 170.

We envision the main heat exchanger to be likely the highly efficient and cost-effective aluminum plate-fin heat exchanger. A part of the higher temperature exchanger could be to be combined with the main heat exchanger, while the part that uses cooling water might be separate.

Although the pressure of the coal gas is boosted to something like 180 atm for a 90% CO₂ capture in this example, it should be emphasized that if more CO₂ capture is needed, this pressure can be further increased, and vice versa.

Many of the concepts proposed for CO₂ capture from coal gas here can also be used for CO₂ capture or removal from CO₂-containing natural gas, especially from those with high concentration of CO₂ and other mixtures of CO₂ with lighter components such as H₂, He, N₂, CO, and methane etc. Such a process can be followed by another process, such as absorption, adsorption, freezing, or membrane separation if more complete removal of CO₂ is desired. The CO₂-rich natural gas is likely fully condensed before it is fed to the stripping column for removing a portion of the CO₂, while the remaining CO₂-methane mixture from the top of the stripping column, which could also contain some small amount of ethane and smaller amounts of heavier hydrocarbons, is fed to another CO₂-methane separation unit, such as an absorption unit.

Before CO₂ sequestration is mandated, the pumped CO₂ can be heated and expanded to generate power—it can be a source of dispatchable power: liquid CO₂ can be accumulated when the demand for electricity is low, but pumped, heated, and expanded in a gas expander to generate power during peak electricity demand hours.

Alternatively, the refrigeration loop can be eliminated and the need for refrigeration of the plant can be provided by heating and vaporizing the liquid CO₂, preferably at least at two or more different pressures. Such a process needs further CO₂ compression (to replace the compression of the refrigerant) to the desired storage pressure, but reduces the amount of fluid to be cooled and heated. The drawback is that the match of the enthalpy—temperature curves of the cooling and heating streams are not as good as the systems with optimized refrigerants.

Simulation was run using Peng Robinson thermodynamic model with the feed gas described in Consonni et al's work for BP Carson (DF2) 500 MW IGCC power plant after sulfur and water removal mentioned previously. By assuming 87% polytropic efficiency for compressors, 90% isentropic efficiency for the major expander, 87% efficiency for the minor expander, 80% for the CO2 pumps, and 97% efficiency for the motors and generators, and using a refrigerant composed of 60% iso-butane, 24% ethane, and 16% ethylene, we came up with the following results:

| 1. CO2 capture (delivered at150 bar) rate: | 10,845 kmol/h | |
|---|---|---|
| | (90.16% recovery), | |
| 2. CO in CO2: | 98 ppm (v), | |
| 3. H2 recovery: | 99.9995%, | |
| 4. CO recovery: | 99.7%, | |
| 5. Power consumption: | | |
| Name of machine | Item No | Power use (kW) |
| Booster compressor stage 1 | (10) | 11,742 |
| Booster compressor stage 2 | (30) | 15,262 (compander) |
| Refrigerant compressor stage 1 | (130) | 3,493 |
| Refrigerant compressor stage 2 | (150) | 4,306 |
| CO2 pump | (100) | 2,027 |
| Major expander | (110) | −15,213 |
| Minor expander | (120) | −203 |

Net power consumption (not including that used by cooling water pump) 21,414 kW

In addition, there will be some power needed for pumping the cooling water and for other purposes. We believe 0.7 MW is a comfortable estimate of that power. The total power consumption is therefore on the order of 22.1 MW. This is over 57% reduction from the 51.75 MW (60.48 MW minus the 8.73 MW used for sulfur removal using a Selexol process) needed in the Selexol-only process, and over 37% reduction from the 35.29 MW of the partial condensation process of Consonni et al. In addition, the fuel gas going to the power generation unit is at 353 K (80° C.), saving some heat for fuel preheating.

The stream composition, flow rates, T, p, and phase conditions are listed in Table 1.

The stripping column has 15 stages in the simulation, and its feed, stream 13, enters the column at stage 5. A boil-up ratio of 0.275 was used in the simulation to reduce the CO content in the bottoms product to below 100 ppm (a higher boil-up ratio, or a higher vapor fraction of stream 13, or a greater flow of stream 13 will allow for a higher level of CO removal to whatever CO level desired but will also increase the spec power for carbon capture somewhat). The heat for the reboiler (8.91 MW, at 293.6 K) can be provided by the gas coming out of a booster compressor stage, e.g., the first stage (11.7 MW available).

In the power calculation, it was assumed that the second stage of the booster compressor and the expanders are mechanically linked to form a compander so that there are no motor losses for that compressor stage (but there is 3% shaft loss on the expanders). Alternatively, the expanders can be coupled to the first stage of the booster compressor (with its compression ratio adjusted to match the power of the compressor with that of the expanders). Detailed machinery calculation is necessary to determine which fits better. However, based on our experience with companders, at least one of the alternatives is likely to work.

For the cost estimate below, the current coal-based power plant site electricity cost without including the cost due to CO2 capture and sequestration will be used to avoid double counting since we think CO2 capture-enhanced oil recovery (EOR) is a business on its own right—if the power plant is close to a mature oilfield or a CO2 pipeline, the oilfield owner is likely willing to pay for $30-38/ton CO2 for use in EOR at an oil price of $25-35/barrel, so carbon capture for EOR can actually be highly profitable if the CO2 capture cost is reduced to $10/ton CO2 level as our process promises. We think a $0.045/kWh power plant site electricity cost is a reasonable estimate.)

Thus, the specific power for CO2 capture using this process is 2.04 kWh/kmol (0.924 kWh/lbmol), or 46 kWh/metric ton (ton afterwards). At a power plant site cost of electricity of $0.045/kWh, the energy cost is $2.07/ton of CO2 captured. Our rough estimate of the capital cost of such a system is $2.5/ton CO2 with a 7 year payback time for a typical power plant of this size (i.e., 70 million CAPEX for the plant construction and maintenance in the example) due to the simplicity of the process and compactness resulting from the higher process stream pressures and lower temperatures, making the sum of capital and energy costs of CO2 capture using this process $4.57/ton. However, this is not a true CO2 capture cost because 1) removing CO2 from the fuel reduces the amount of the high pressure gas for power generation, which will have to be made up by compressing more air in the gas turbine compressor, and 2) some of the available energy in the feed gas in the process is used. We evaluated these two factors and came up with a power penalty of 58.6 MW, or 120 kWh/ton CO2, which is worth $5.36/ton CO2 at $0.045/kWh if the cost of the expander (needed to recover work from the high pressure fuel gas) saved and the incremental cost of the turbine compressor size increase (needed for compressing more air to make up for the loss of CO2 in the fuel gas) cancel out, resulting in a more fair cost of CO2 capture of $9.9/ton CO2 without taking credit for the heat recovered by the fuel stream or including the cost of operators.

### Example 2. Coal Gas Purification for Methanol Synthesis

Coal gas after water-gas shift reaction is used for producing the feed gas for methanol synthesis after removing the acidic gases (CO₂ and small amounts of H₂S and COS). In a conventional system, a physical absorbent such as methanol is used to remove the acidic gases. Using the present invention, the CO₂ will be removed by a partial condensation followed by stripping to remove the hydrogen and CO dissolved in the CO₂-rich liquid from the partial condensation process following some of the features described above and make the feed gas to the methanol synthesis process (also called synthesis gas) to close to stoichiometric feed ratio, r, which satisfy the stoichiometric value of close to, but smaller than, 2, such as 1.7-1.95 (because there will be more CO₂ and CO lost to the crude methanol than hydrogen in the post reaction separation process):

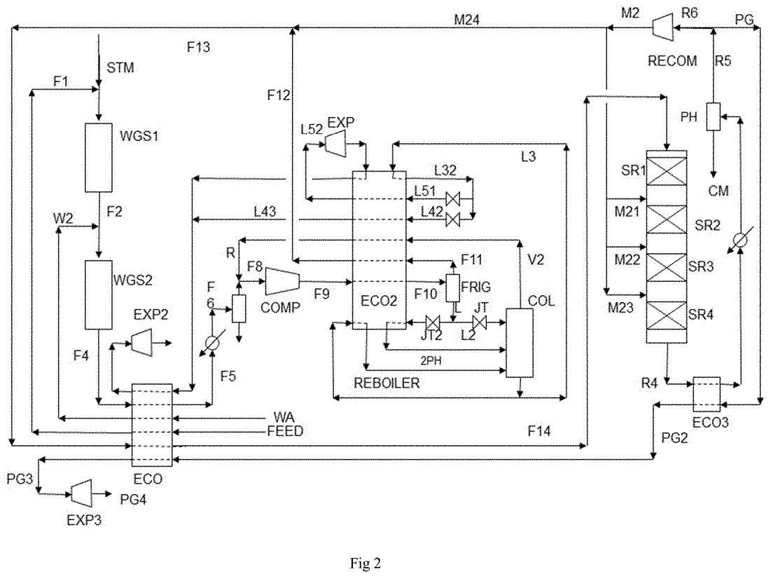

r=(F_{H2}−F_{CD})/(F_{CD}+F_{CM})

in which F_{H2}, F_{CD}, and F_{CM}. are respectively the molar component feed rates of hydrogen, carbon dioxide, and carbon monoxide. FIG. 2 shows such a process.

In the process in FIG. 2, the coal gas from a coal gasifier (after sulfur removal), such as that at 600 psia, FEED, is heated (in heat exchanger ECO in this example) to a temperature suitable for water-gas shift reaction, and the resultant heated coal gas, F1, is mixed with steam, STM, and fed to the first water-gas shift reactor, WGS1, to convert some of the CO (and steam) into CO₂ and H₂. Since this reaction is moderately exothermic, the outlet stream has a higher temperature than that at the inlet. The effluent of water-gas shift reactor WGS1, F2, is the mixed the water heated by ECO, W2, and fed to the second water-gas shift reactor, WGS2, to further convert more CO and water into CO₂ and H₂. The effluent of WGS2, F4, is then cooled in heat exchanger ECO and then further cooled in a trim cooler, TC, and then phase-separated in the knockout tank, KNOCKOUT, into a waste water stream, WW, and a synthesis gas richer in H₂ and CO₂. The excess moisture is further removed by an temperature swing (or pressure swing) adsorption separation unit, MS, to remove the moisture. The dry gas, F6, is then mixed with the recycle gas, R, and compressed in the CO₂-rich coal gas compressor, COMP, to a pressure that is close to or higher than the critical pressure of CO₂, such as 1500 psig. The compressed gas, F9, is then cooled and partially condensed in heat exchanger ECO2 to result in a 2-phase stream, F10. The 2-phase stream F10 is then fed to the phase separator, FRIG. The vapor phase from the top of FRIG, F11, has the desired r value of close to but smaller than 2, such as in 1.7-1.95 range. This ratio can be controlled by the temperature of the 2-phase stream coming out of ECO2, which requires adjusting the pressure of the lowest pressure liquid CO₂ to be vaporized before being fed to ECO2 and constrained by the triple point temperature of CO₂, which is close to 216.6 K (−56.6° C.), and/or the discharge pressure of the compressor, COMP. It can also be increased by adding a partial condenser, such as a Dephlegmator, at the top of the stripping column, COL, an option not shown in the process of FIG. 2 but selected in that of FIG. 1. Stream 11 is then heated, mixed with the recycle stream from methanol synthesis, M24, to form the mixed syngas stream, F13, which is then heated in the economizer ECO, to form the feed stream to the first section of the methanol synthesis reactor, SR1. The liquid stream, 1, from the phase separator, FRIG, is then split into two streams and let down in pressure through valves JT and JT2. The stream coming out of JT is fed to the top of the stripping column, COL, directly. The stream coming out of JT2 is heated in ECO2 to a suitable temperature to obtain a two-phase stream, 2PH, which is fed to the stripping column, COL, at an intermediate location. COL is reboiled in a warmer section of ECO2. The vapor stream, V2, from COL, is heated in ECO2 and resultant heated gas, R, is mixed with stream F6 and fed to the compressor (alternatively, it could be recycled to the entrance of one of the water-gas shift reactors WGS1 or WGS2. This is not chosen in the process of FIG. 1).

The bottoms liquid product, L3, of the stripping column COL is first subcooled in ECO2 to a lower temperature, and then taken out of ECO2 and split into two streams, and then letdown in pressure through valves JT3 and JT4. The pressure of the stream, L42, coming out of JT3, is reduced to a lower level and therefore the resulting two-phase stream provides refrigeration at a lower temperature. It is fed to the bottom of ECO2 (shown to be on the right-hand side) and heated and vaporized in ECO2. Another substream of L3 is let down to a higher pressure than that of L42. The resultant higher-pressure two-phase stream, L51, is introduced into ECO2 at a position that is somewhat higher than the bottom and heated and vaporized in ECO2. The resultant vapor, V52, is expanded in expander, EXP, to a pressure that is similar to that of L42, to generate refrigeration and recover work. The expander exhaust stream, V53, from expander EXP is then reintroduced to ECO2 to an intermediate location and heated in the warmer section of ECO2. The resultant heated vapor, V54, is then mixed with the heated stream, V43, vaporized from L42 in ECO2, to form a combined CO₂ gas stream, V44,

The combined CO₂ gas, V44, which is still at a pressure that is much greater than the atmospheric pressure, is further heated in ECO. The further heated CO₂ gas, V45, is then expanded in expander EXP3 to a pressure close to that of the atmosphere to generate power. The exhaust from EXP3 is then vented into atmosphere. This part is not necessary if a pressurized CO₂ stream is used, for example for further compression to a high pressure for sequestration, or used in enhanced oil recovery, or for other purposes.

The remaining part, the methanol synthesis section, on the right-hand side of FIG. 2, is not very relevant to the subject of interest. For the sake of completion, they are explained as follows: the methanol synthesis reactor has 4 sections: SR1, SR2, SR3, and SR4, from the entrance to the exit. Three of the recycle gas streams, M21, M22, M23, are fed to the reactor between the sections. The effluent of the last stage of the methanol synthesis reactor SR4, R4, is first cooled in Economizer ECO3, and then further cooled and partially condensed by cooling water, and then fed to a phase separator, PH. The liquid phase from PH is the crude methanol, which is mostly methanol and water, while the vapor stream, R5, which is mostly unconverted H₂, CO, and CO₂, but also includes some inert gas, is split into two streams: the major stream, R6, which is compressed. The compressed recycle gas, M2, is then split into 4 substreams: M21, M22, M23, and M24. Streams M21, M22, and M23 are fed to the methanol synthesis reactor while M24 is mixed with stream F12 as explained before. The purge gas, PG, is heated in ECO3, and then in ECO. The heated purge gas, PG3, is expanded in expander EXP3. The exhaust of EXP3, PG4, can be used as fuel. ECO3 may have excess heat that can be used for other purposes such as for crude methanol purification but this has no relevance to the subject of this document and will not be discussed further.

Simulation was carried out using the feed gas FEED at 600 psia (41.38 bara), steam (STM), and water (WA) as in the example of using coal gas for methanol synthesis at 1,500 psia in a report by SRI, “Methanol, SUPPLEMENT B, a private report by the process economics program, SRI International, Menlo Park, Calif. 94025 (1981) (to be referred as “the SRI report”) for comparison purposes. The relevant stream conditions of the process are in Table 2. Some of the stream data in methanol synthesis part (on the right-hand side), which are not relevant to the subject of interest of this document, are not shown. Also note in the “Stream flow” section of Table 2, L1 stands for methanol. It only exists in streams M2, M21, M22, M23, M24, F13, and F14.

Note that since there is no distinction between nitrogen, argon, and any other inert gases and therefore are lumped into “N2” in Table 2.

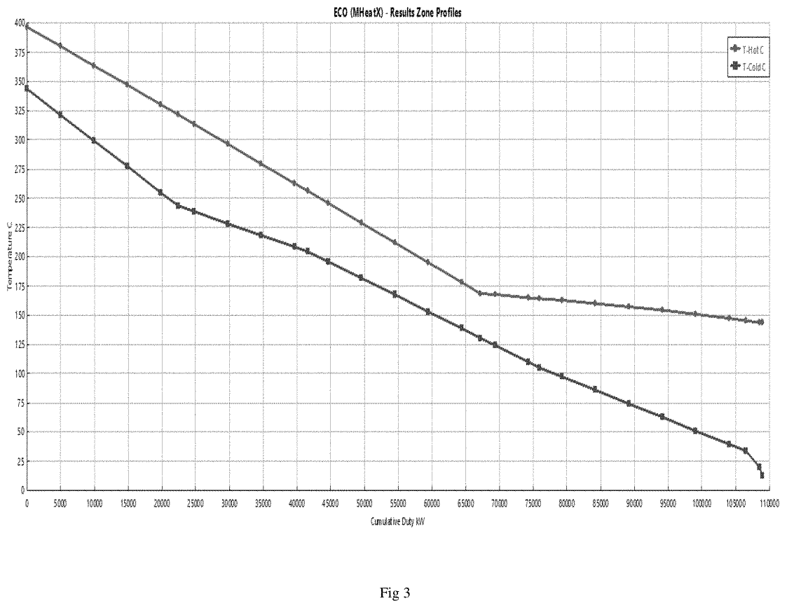

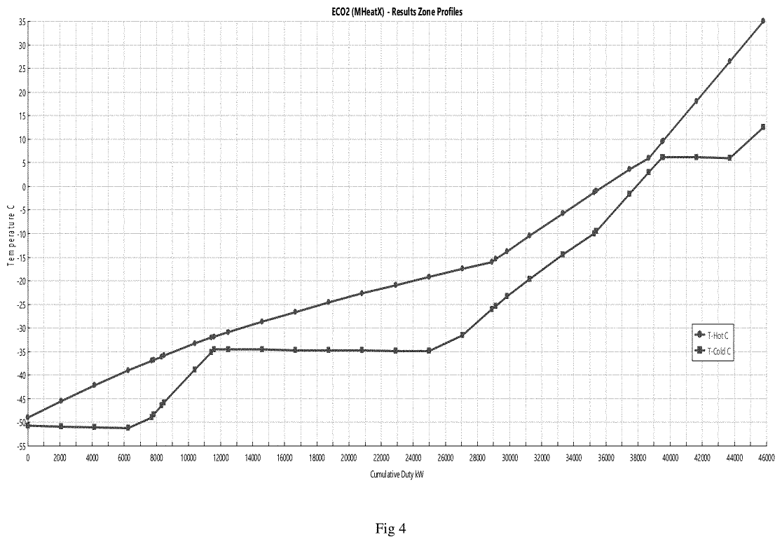

The H-T curves of the hot and cold streams of the heat exchangers ECO and ECO2 are shown in FIGS. 3 and 4. Although the process shows that ECO and ECO2 are two multichannel heat exchangers, each of them can be a combination of multiple physical heat exchangers in parallel or in series, or a combination of parallel and series heat exchangers.

As can be seen from FIG. 3 that there is still substantial heat at around 150° C. available in ECO and somewhat lower in stream F5 for higher temperature use than heating the streams from ECO2, and more heat can be provided by the further cooling of the water-gas shift reactor effluent. Such heat can be used for such duties as reboiling at the bottoms of the distillation columns for the separation of the crude methanol downstream of the methanol synthesis reaction. That is beyond the discussion here, and the processes steps are not shown in FIG. 2.

Unlike in the conventional plant using Rectisol process for CO₂ removal, this process does not need an external refrigeration unit: pressure reduction of the liquid CO₂ to lower levels before vaporization, the Joule-Thompson effect (refrigeration caused by pressure drop of the product gases vs feed gas), and expansion of a portion of the CO₂-rich gas are enough to provide the refrigeration and heat transfer □T necessary to cool and partially condense the feed gas in ECO2. Even then, the CO₂ gas coming out of ECO2 is still at an elevated pressure and is therefore heated further in ECO and then expanded, in EXP2, to generate power of 10.85 MW (assuming 89% isentropic efficiency and 96% mechanical efficiency). This and the 1.1 MW work recovered from the cold expander, EXP, allows for a recovery of 11.95 MW of electricity from expansion of the product CO₂, that can be used to reduce the power consumption of the process. This compares with the 5,000 ton of 211 K (−80° F. K) refrigeration needed for the Rectisol process (absorption by cold methanol) in the base case in the SRI report mentioned above, whose equipment cost was shown to be $24 million in 1979 dollars according to the SRI report. Since in this process, 34.4% of the gas compressed is CO₂, versus only about 3% in the base case, the synthesis gas feed compressor work for compressing to 1,500 psig in this process is higher by 34% of the compressor COMP work of 21.079 kW (this does not include the duty of the compression for the recycle gas in the downstream methanol synthesis unit, which is not shown in FIG. 2, in both cases), or 7.17 kW, than in the base case. The net power (not counting that used to generate the 5,000 ton refrigeration) saving is therefore 11.95−7.17=4.78 MW. If the COP of the refrigeration is 2, the 5,000 ton of 211 K (−80° F.) refrigeration is worth additional 5,000*3.5/2/1,000=8.75 MW. Total savings of electricity using this process over that using Rectisol as reported in the SRI report is therefore on the order of 13.53 MW (worth 40.6 million at 3,000.kW valuation). This is in addition to the elimination of the 1,405 kmol/hr of nitrogen used in the (methanol regeneration system of the) base case. The cost of the two expanders and the larger compressor for compressing the gas from about 600 psia (41.38 bara) to 1,500 psia (103.4 bara) as well as the use of a separate methanol synthesis off-gas recycle compressor (not shown) will reduce the 24 million (USD of 1981, according to the SRI report) capital cost benefit of eliminating the refrigeration unit somewhat, while elimination of the flash gas compressor needed in the conventional processes should further increase the capital cost benefit of this process.

To have a sense of the cost of compressors (excluding that of the refrigeration system), the total compressor cost in the base case is 14.671 million shown in the conventional system according to the SRI report. This figure includes the costs of the coalgas compressor that compresses the raw coalgas from 65 psia to 600 psia (likely the most expensive compressor, not shown in this process, and not needed in plants using most modern gasifiers), the flash gas compressor (not needed in the process of FIG. 2) in the Rectisol process, and the synthesis gas compressor that compresses the syngas from a bit below 600 psia to 1,500 psia, and recycle gas from 1,250 psia to 1,500 psia. The cost of the two expanders is estimated to be in a couple of million dollars. The net capital saving by using the process in FIG. 2 is therefore expected to be still in 8 digits in 1981 US dollars, while the combined capital and energy savings are likely more than 50 million for such a plant.

Since no methanol is used for CO₂ removal in this process, the heat exchanger duties, and therefore the heat exchanger areas, for cooling and heating methanol are eliminated Sulfur removal can be carried out in an absorption column at somewhat above ambient temperature and a reduced amount of absorbent while the regeneration of the absorbent can be similar to that used in the conventional processes, as is the loss of methanol due to elimination of the Rectisol process for CO₂ removal. Alternatively, other processes for sulfur removal can also be considered.

To further reduce cost and improve efficiency, the expanders can be directly coupled with the compressor or compressors, which eliminates the losses in the alternators (both the generators and motor(s)) and gears (on both expander side and generator side). The power benefit of coupling the expanders and compressors alone is likely to be on the order of 1 MW for such a 4,000 ton methanol/d plant (ton-short ton), and the cost saving due to elimination of the gears for the expanders, the motors, and alternators of the same capacity level should also be worth quite bit of money.

Not much progresses have been made in coal gas CO₂ removal technologies since 1981, so the cost comparison with the base case in the SRI report should be still largely valid.

Alternatively, a refrigeration system similar to that in FIG. 1 can be used and the liquid CO₂ can be heated and expanded, likely in two or more expanders if the CO₂ gas is eventually vented to atmosphere, to generate power. Such a system can produce power on demand: the liquid CO₂ can be stored during off-peak period and heated and expanded to generate electricity during the peak demand hours. Besides, such a system has the benefit of better match of the enthalpy—temperature curves of the cooling and heating streams so that the system can be made more efficient.

### Example 3. Membrane—Condensation/Stripping Hybrid

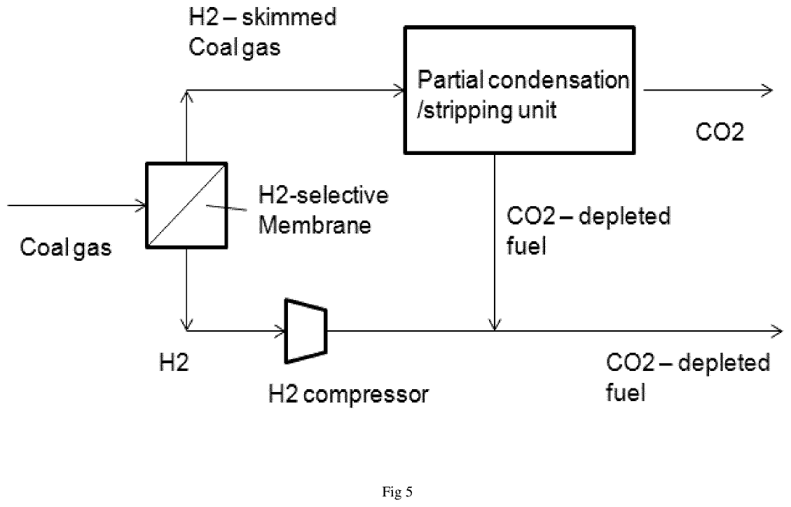

Certain hydrogen selective membranes such as certain metallic membranes and ceramic membranes are known to have (hydrogen over CO₂ and other gases) selectivity values of much greater than 50, such as greater than 10,000. Such a membrane can be combined with a partial condensation/stripping process similar to that shown in FIG. 1 (or more preferably a system similar to that in FIG. 1 but without the refrigeration system so that the refrigeration for cooling and partially condensing the feed mixture is provided by vaporization of the liquid CO₂ at two or more pressures) to reduce the amount of gas to be processes in the sub-ambient temperature process, and to increase CO₂ recovery of the system. FIG. 5, as an example, shows a block diagram of such a process with a membrane that favors hydrogen permeation. Note the “partial condensation-stripping unit” is likely to be similar to that in FIG. 1 although the booster compressor and the intercooler (10, 20, and 30 in FIG. 1) may not be necessary due to the higher CO₂ concentration of the feed to the partial condensation/stripping unit, which is the retentate of the membrane unit, due to removal of some H₂ by the membrane unit, and the expander may have a lower pressure ratio and therefore have a different temperature range. The advantages of such a process are that the booster compressor can be eliminated (or reduced) for the same level of CO₂ capture, as are the losses associated with the pressure reduction of the liquid CO₂ from the phase separator, and that the hydrogen gas that is separated by the membrane unit does not need to be cooled and then heated, eliminating the need for heat exchanger area of those molecules, and the associated ΔT and Δp losses.

While coal gas is mentioned in FIG. 5, it should not be construed as a constraint. Any feed gas containing a significant amount of hydrogen can use such a process, especially synthesis gas produced from steam reformer, autothermal reformer, or partial oxidation of natural gas.

It is understood that the examples and embodiments described herein are for illustrative purposes only, and that changes could be made to the embodiments described above without departing from the broad inventive concept thereof. It is understood, therefore, that this invention is not limited to the particular embodiments disclosed, but it is intended to cover modifications within the spirit and scope of the invention as defined by the appended claims

TABLE 1
Stream compositions, flow rate, T, P, Phase conditions of the process in Case 1

| Stream | 1 | 2 | 3 | 5 | 6 | 7 | 8 | 9 | 11 | 11a | 11b | 12a | 13 | 14 | 15 |
|---|---|---|---|---|---|---|---|---|---|---|---|---|---|---|---|
| Mole Frac | | | | | | | | | | | | | | | |
| H2 | 0.551275 | 0.551275 | 0.551275 | 0.551275 | 0.551275 | 0.908408 | 0.908408 | 0.908408 | 0.045944 | 0.045944 | 0.045944 | 0.045944 | 0.045944 | 0.208271 | 0.208271 |
| CO2 | 0.431899 | 0.431899 | 0.431899 | 0.431899 | 0.431899 | [symbol] | [symbol] | [symbol] | 0.948237 | 0.948237 | 0.948237 | 0.948237 | 0.948237 | 0.700732 | 0.700732 |
| methane | [symbol] | [symbol] | [symbol] | [symbol] | [symbol] | [symbol] | [symbol] | [symbol] | [symbol] | [symbol] | [symbol] | [symbol] | [symbol] | 0.000779 | 0.000779 |
| N2 | 0.003514 | 0.003514 | 0.003514 | 0.003514 | 0.003514 | 0.005183 | 0.005183 | 0.005183 | 0.001152 | 0.001152 | 0.001152 | 0.001152 | 0.001152 | [symbol] | [symbol] |
| CO2 | [symbol] | [symbol] | [symbol] | [symbol] | [symbol] | 0.01784 | 0.01784 | 0.01784 | 0.003882 | 0.003882 | 0.003882 | 0.003882 | 0.003882 | 0.020411 | 0.020411 |
| AR | 0.001045 | 0.001045 | 0.001045 | 0.001045 | 0.001045 | 0.001327 | 0.001327 | 0.001327 | [symbol] | [symbol] | [symbol] | [symbol] | [symbol] | [symbol] | [symbol] |
| Ethylene | 0 | 0 | 0 | 0 | 0 | 0 | 0 | 0 | 0 | 0 | 0 | 0 | 0 | 0 | 0 |
| Ethane | 0 | 0 | 0 | 0 | 0 | 0 | 0 | 0 | 0 | 0 | 0 | 0 | 0 | 0 | 0 |
| Isobutane | 0 | 0 | 0 | 0 | 0 | 0 | 0 | 0 | 0 | 0 | 0 | 0 | 0 | 0 | 0 |
| Water | 0 | 0 | 0 | 0 | 0 | 0 | 0 | 0 | 0 | 0 | 0 | 0 | 0 | 0 | 0 |
| Total Flow kmol/hr | 27849.17 | 27849.17 | 27849.17 | 27849.17 | 27849.17 | 16317.26 | 16317.26 | 16317.26 | 11531.9 | 8072.333 | 3459.571 | 8072.333 | 8072.333 | 2673.131 | 2673.13 |
| Total Flow kg/hr | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| Total Flow l/min | [symbol] | [symbol] | [symbol] | [symbol] | [symbol] | [symbol] | [symbol] | 148054 | [symbol] | [symbol] | 2240.349 | [symbol] | [symbol] | [symbol] | 4805.558 |
| Temperature K | 298.16 | 345.3802 | 298.15 | 360.926 | 218.15 | 218.1486 | 330 | 214.4056 | 218.1496 | 218.1496 | 218.1496 | 121.2721 | 786.6191 | 276.1232 | 218.15 |
| Pressure atm | [symbol] | 94 | 93.9 | 180 | 179.6 | [symbol] | [symbol] | [symbol] | [symbol] | [symbol] | [symbol] | [symbol] | [symbol] | [symbol] | [symbol] |
| Vapor Frac | 1 | 1 | 1 | 1 | 0.585895 | 1 | 1 | 1 | 0 | 0 | 0 | 0.039287 | [symbol] | 1 | 0.25576 |
| Liquid Frac | 0 | 0 | 0 | 0 | 0.414105 | 0 | 0 | 0 | 1 | 1 | 1 | [symbol] | 0.45 | 0 | 0.74424 |
| Solid Frac | 0 | 0 | 0 | 0 | 0 | 0 | 0 | 0 | 0 | 0 | 0 | 0 | 0 | 0 | 0 |

| Stream | 16 | 17 | 21 | 22 | 18 | 19 | 29 | 31 | 101 | 102 | 103 | 104 | 105 | 106 | 121 | 122 |
|---|---|---|---|---|---|---|---|---|---|---|---|---|---|---|---|---|
| Mole Frac | | | | | | | | | | | | | | | | |
| H2 | [symbol] | [symbol] | [symbol] | [symbol] | [symbol] | [symbol] | [symbol] | [symbol] | 0 | 0 | 0 | 0 | 0 | 0 | 0 | 0 |
| CO2 | 0.13117 | 0.13117 | 0.977082 | [symbol] | [symbol] | [symbol] | [symbol] | [symbol] | 0 | 0 | 0 | 0 | 0 | 0 | 0 | 0 |
| methane | 0.001816 | 0.001816 | [symbol] | [symbol] | [symbol] | [symbol] | [symbol] | [symbol] | 0 | 0 | 0 | 0 | 0 | 0 | 0 | 0 |
| N2 | 0.01888 | 0.01888 | 0.001638 | [symbol] | [symbol] | [symbol] | [symbol] | [symbol] | 0 | 0 | 0 | 0 | 0 | 0 | 0 | 0 |
| CO2 | [symbol] | [symbol] | [symbol] | [symbol] | [symbol] | [symbol] | [symbol] | [symbol] | 0 | 0 | 0 | 0 | 0 | 0 | 0 | 0 |
| AR | [symbol] | [symbol] | [symbol] | [symbol] | [symbol] | [symbol] | [symbol] | [symbol] | 0 | 0 | 0 | 0 | 0 | 0 | 0 | 0 |
| Ethylene | 0 | 0 | 0 | 0 | 0 | 0 | 0 | 0 | 0.16 | 0.16 | 0.16 | 0.16 | 0.16 | 0.36 | 0 | 0 |
| Ethane | 0 | 0 | 0 | 0 | 0 | 0 | 0 | 0 | 0.24 | 0.24 | 0.24 | 0.24 | 0.24 | 0.24 | 0 | 0 |
| Isobutane | 0 | 0 | 0 | 0 | 0 | 0 | 0 | 0 | 0.6 | 0.6 | 0.6 | 0.6 | 0.6 | 0.6 | 0 | 0 |
| Water | 0 | 0 | 0 | 0 | 0 | 0 | 0 | 0 | 0 | 0 | 0 | 0 | 0 | 0 | 1 | 1 |
| Total Flow kmol/hr | 683.0805 | 683.6805 | 1989.489 | [symbol] | [symbol] | [symbol] | [symbol] | [symbol] | [symbol] | [symbol] | [symbol] | [symbol] | [symbol] | [symbol] | [symbol] | 65000 |
| Total Flow kg/hr | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| Total Flow l/min | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| Temperature K | 218.15 | 293.35 | 218.15 | [symbol] | [symbol] | [symbol] | [symbol] | [symbol] | 293.15 | [symbol] | 298.15 | [symbol] | [symbol] | [symbol] | 293.15 | [symbol] |
| Pressure atm | [symbol] | [symbol] | [symbol] | [symbol] | [symbol] | [symbol] | [symbol] | [symbol] | 2.1 | [symbol] | [symbol] | [symbol] | 8.7 | 2.2 | 1.1 | 1 |
| Vapor Frac | 1 | 1 | 0 | 0 | 1 | 1 | 0 | 1 | 1 | 1 | 1 | 1 | 0 | [symbol] | 0 | 0 |
| Liquid Frac | 0 | 0 | 1 | 1 | 0 | 0 | 1 | 0 | 0 | 0 | 0 | 0 | 1 | [symbol] | 1 | 1 |
| Solid Frac | 0 | 0 | 0 | 0 | 0 | 0 | 0 | 0 | 0 | 0 | 0 | 0 | 0 | 0 | 0 | 0 |

[symbol]

indicates data missing or illegible when filed

TABLE 2
Results of simulation for the process in FIG. 2.

| | 2PH | F1 | F2 | F3 | F4 | F5 | F6 | F7 | F8 |
|---|---|---|---|---|---|---|---|---|---|
| Mole Flow | | | | | | | | | |
| kmol/hr | | | | | | | | | |
| H2 | 92.54083 | 5.17E+03 | 0.60E+03 | 9.60E+03 | 1.18E+04 | 1.18E+04 | 1.18E+04 | 1.18E+04 | 1.19E+04 |
| CO | 96.61635 | 9.64E+03 | 5220.895 | 5220.895 | 3028.894 | 3028.894 | 3028.891 | 3028.891 | 3189.319 |
| CO2 | 3564.656 | 1319.66 | 5742.639 | 5742.639 | 7934.64 | 7934.64 | 7933.645 | 7933.645 | 8047.855 |
| H2O | 0 | 285.0676 | 4422.677 | 8202.429 | 6010.428 | 6010.428 | 35.45508 | 0 | 0 |
| N2 | 6.71206 | 2.06E+02 | 205.8318 | 205.8318 | 205.8318 | 205.8318 | 205.8316 | 205.8316 | 216.9593 |
| L1 | 0 | 0 | 0 | 0 | 0 | 0 | 0 | 0 | 0 |
| Total Flow | 3760.525 | 16752.3 | 25312.89 | 29092.64 | 29092.64 | 29092.64 | 23116.2 | 22957.64 | 23397.64 |
| kmol/hr | | | | | | | | | |
| Total Flow | 1.60E+05 | 3.54E+05 | 5.08E+05 | 5.76E+05 | 5.76E+05 | 5.76E+05 | 4.69E+05 | 4.64E+05 | 4.74E+05 |
| kg/hr | | | | | | | | | |
| Total Flow | 5698.907 | 3.45E+05 | 6.74E+05 | 5.78E+05 | 6.67E+05 | 3.68E+05 | 2.41E+05 | 2.40E+05 | 2.44E+05 |
| l/min | | | | | | | | | |
| Temperature | −10 | 343.3333 | 519.1735 | 318.8045 | 396.7555 | 143.3623 | 35 | 35 | 34.57992 |
| C. | | | | | | | | | |
| Pressure bar | 42.38179 | 42.08179 | 41.58179 | 41.16854 | 40.66854 | 40.36854 | 40.16854 | 40.16854 | 40.16854 |
| Vapor Frac | 0.1258341 | 1 | 1 | 1 | 1 | 0.8892142 | 1 | 1 | 1 |
| Liquid Frac | 0.8741659 | 0 | 0 | 0 | 0 | 0.1107858 | 0 | 0 | 0 |
| Average MW | 42.53678 | 21.12915 | 20.07606 | 19.80832 | 19.80832 | 19.80832 | 20.27049 | 20.19068 | 20.24448 |
| | F9 | F10 | F11 | F12 | F13 | F14 | FEED | L | L1 |
| Mole Flow | | | | | | | | | |
| kmol/hr | | | | | | | | | |
| H2 | 1.19E+04 | 1.19E+04 | 1.18E+04 | 1.18E+04 | 2.03E+04 | 20324.38 | 5174.321 | 154.2347 | 92.54083 |
| CO | 3189.319 | 3189.319 | 3028.292 | 3028.292 | 3842.965 | 3842.965 | 9643.874 | 161.0272 | 96.61635 |
| CO2 | 8047.855 | 8047.855 | 2106.761 | 2106.761 | 4045.672 | 4045.672 | 1319.66 | 5941.094 | 3564.656 |
| H2O | 0 | 0 | 0 | 0 | 5.729822 | 5.729822 | 285.0676 | 0 | 0 |
| N2 | 216.9593 | 216.9593 | 205.7725 | 205.7725 | 2494.76 | 2494.76 | 205.8318 | 11.18677 | 6.71206 |
| L1 | 0 | 0 | 0 | 0 | 62.46315 | 62.46315 | 0 | 0 | 0 |
| Total Flow | 23397.64 | 23397.64 | 17130.1 | 17130.1 | 30775.97 | 30775.97 | 16752.3 | 5267.542 | 3760.525 |
| kmol/hr | | | | | | | | | |
| Total Flow | 4.74E+05 | 4.74E+05 | 2.07E+05 | 2.07E+05 | 3.99E+05 | 3.99E+05 | 3.54E+05 | 2.67E+05 | 1.60E+05 |
| kg/hr | | | | | | | | | |
| Total Flow | 9.37E+04 | 5.54E+04 | 5.14E+04 | 6.77E+04 | 1.31E+05 | 2.28E+05 | 2.65E+05 | 4.14E+03 | 2.48E+03 |
| l/min | | | | | | | | | |
| Temperature | 35 | −49 | −49.01724 | 12.44019 | 33.4558 | 243.3333 | 204.4444 | −49.01724 | −49.01724 |
| C. | | | | | | | | | |
| Pressure bar | 103.2214 | 103.0214 | 102.8214 | 106.6214 | 102.6214 | 102.4214 | 42.38179 | 102.8214 | 102.8214 |
| Vapor Frac | 1 | 0.7320617 | 1 | 1 | 1 | 1 | 1 | 0 | 0 |
| Liquid Frac | 0 | 0.2679383 | 0 | 0 | 0 | 0 | 0 | 1 | 1 |
| Average MW | 20.24448 | 20.24448 | 12.08819 | 12.08819 | 12.95346 | 12.95346 | 21.12915 | 42.53678 | 42.53678 |
| | L2 | L3 | L4 | L12 | L32 | L42 | L51 | LCD | M2 |
| Mole Flow | | | | | | | | | |
| kmol/hr | | | | | | | | | |
| H2 | 6.17E+01 | 9.72E−06 | 3.40E−06 | 9.25E+01 | 9.72E−06 | 3.40E−06 | 6.32E−06 | 0 | 42675.55 |
| CO | 64.4109 | 0.5991773 | 0.2097121 | 96.61635 | 0.5991773 | 0.2097121 | 0.3894653 | 0.535866 | 4073.366 |
| CO2 | 2376.437 | 5826.884 | 2039.409 | 3564.656 | 5826.884 | 2039.409 | 3787.475 | 1785.623 | 9694.556 |
| H2O | 0 | 0 | 0 | 0 | 0 | 0 | 0 | 0 | 28.64911 |
| N2 | 4.474706 | 0.0590444 | 2.07E−02 | 6.71206 | 0.0590444 | 0.0206655 | 0.0383789 | 0.0607314 | 11444.94 |
| L1 | 0 | 0 | 0 | 0 | 0 | 0 | 0 | 0 | 312.3157 |
| Total Flow | 2507.017 | 5827.542 | 2039.64 | 3760.525 | 5827.542 | 2039.64 | 3787.903 | 1786.22 | 68229.38 |
| kmol/hr | | | | | | | | | |
| Total Flow | 1.07E+05 | 2.56E+05 | 8.98E+04 | 1.60E+05 | 2.56E+05 | 8.98E+04 | 1.67E+05 | 7.86E+04 | 9.58E+05 |
| kg/hr | | | | | | | | | |
| Total Flow | 1.65E+03 | 4.80E+03 | 1.39E+03 | 3.27E+03 | 3958.125 | 10337.66 | 3907.047 | 1.47E+03 | 3.12E+05 |
| l/min | | | | | | | | | |
| Temperature | −49.01724 | 6.08238 | −32 | −48.27403 | −32 | −50.71027 | −34.60036 | 6.091955 | 59.49438 |
| C. | | | | | | | | | |
| Pressure bar | 102.8214 | 40.69562 | 40.69562 | 42.38179 | 40.69562 | 6.5 | 12 | 40.81696 | 103.4214 |
| Vapor Frac | 0 | 0 | 0 | 0.0346091 | 0 | 0.1040092 | 0.0155669 | 0 | 1 |
| Liquid Frac | 1 | 1 | 1 | 0.9653909 | 1 | 0.8959908 | 0.984433 | 1 | 0 |
| Average MW | 42.53678 | 44.00799 | 44.00799 | 42.53678 | 44.00799 | 44.00799 | 44.00799 | 44.00446 | 14.03965 |
| | M21 | M22 | M23 | M24 | S-WA | STM | V2 | V43 | V44 |
| Mole Flow | | | | | | | | | |
| kmol/hr | | | | | | | | | |
| H2 | 11380.15 | 11380.15 | 1.14E+04 | 8.54E+03 | 0 | 0 | 154.2347 | 3.40E−06 | 9.72E−06 |
| CO | 1086.231 | 1086.231 | 1086.231 | 814.6731 | 0 | 0 | 160.4281 | 0.2097121 | 0.5991772 |
| CO2 | 2585.215 | 2582.215 | 2585.215 | 1938.911 | 0 | 0 | 114.2095 | 2039.409 | 5826.884 |
| H2O | 7.639762 | 7.639762 | 7.639762 | 5.729822 | 35.45508 | 8560.589 | 0 | 0 | 0 |
| N2 | 3051.984 | 3051.984 | 3.05E+03 | 2288.988 | 0 | 0 | 11.12772 | 0.0206655 | 0.0590444 |
| L1 | 83.2842 | 83.2842 | 83.2842 | 62.46315 | 0 | 0 | 0 | 0 | 0 |
| Total Flow | 18194.5 | 18194.5 | 18194.5 | 13645.88 | 158.5549 | 8560.589 | 440 | 2039.64 | 5827.542 |
| kmol/hr | | | | | | | | | |
| Total Flow | 2.55E+05 | 2.55E+05 | 2.55E+05 | 1.92E+05 | 5.05E+03 | 1.54E+05 | 1.01E+04 | 89760.45 | 2.56E+05 |
| kg/hr | | | | | | | | | |
| Total Flow | 8.33E+04 | 83263.54 | 8.33E+04 | 6.24E+04 | 1.01E+02 | 1.57E+05 | 3.13E+03 | 1.23E+05 | 3.51E+05 |
| l/min | | | | | | | | | |
| Temperature | 59.57568 | 59.57568 | 59.57568 | 59.57568 | 35 | 343.3333 | −45.87425 | 12.44019 | 12.44019 |
| C. | | | | | | | | | |
| Pressure bar | 103.4214 | 103.4214 | 103.4214 | 103.4214 | 40.16854 | 42.38179 | 40.67907 | 6.3 | 6.3 |
| Vapor Frac | 1 | 1 | 1 | 1 | 0 | 1 | 1 | 1 | 1 |
| Liquid Frac | 0 | 0 | 0 | 0 | 1 | 0 | 0 | 0 | 0 |
| Average MW | 14.03965 | 14.03965 | 14.03965 | 14.03965 | 31.82569 | 18.01528 | 23.05145 | 44.00799 | 44.00799 |
| | V45 | V52 | V53 | V54 | VCD | VNT | W2 | WA | WW |
| Mole Flow | | | | | | | | | |
| kmol/hr | | | | | | | | | |
| H2 | 9.72E−06 | 6.32E−06 | 6.32E−06 | 6.32E−06 | 0.00E+00 | 9.72E−06 | 0 | 0 | 0.0280633 |
| CO | 0.5991772 | 0.3894653 | 0.3894652 | 0.3894652 | 0.535866 | 0.5991772 | 0 | 0 | 3.42E−03 |
| CO2 | 5826.884 | 3787.475 | 3787.475 | 3787.475 | 1785.623 | 5826.884 | 0 | 0 | 0.9944971 |
| H2O | 0 | 0 | 0 | 0 | 0 | 0 | 3779.752 | 3779.752 | 5974.973 |
| N2 | 0.0590444 | 0.0383789 | 0.0383789 | 0.0383789 | 0.0607314 | 0.0590444 | 0 | 0 | 2.90E−04 |
| L1 | 0 | 0 | 0 | 0 | 0 | 0 | 0 | 0 | 0 |
| Total Flow | 5827.542 | 3787.903 | 3787.903 | 3787.903 | 1786.22 | 5827.542 | 3779.752 | 3779.752 | 5976.442 |
| kmol/hr | | | | | | | | | |
| Total Flow | 2.56E+05 | 1.67E+05 | 1.67E+05 | 1.67E+05 | 7.86E+04 | 2.56E+05 | 68093.29 | 68093.29 | 1.08E+05 |
| kg/hr | | | | | | | | | |
| Total Flow | 8.15E+05 | 1.17E+05 | 1.89E+05 | 2.28E+05 | 1.10E+04 | 3.68E+06 | 1243.065 | 1136.289 | 1823.587 |
| l/min | | | | | | | | | |
| Temperature | 343.3333 | 12.44019 | −23.2489 | 12.44019 | 6.041463 | 189.6209 | 105 | 20 | 35 |
| C. | | | | | | | | | |
| Pressure bar | 6.1 | 11.8 | 6.5 | 6.3 | 40.61696 | 1.013529 | 41.16854 | 41.36854 | 40.16854 |
| Vapor Frac | 1 | 1 | 1 | 1 | 1 | 1 | 0 | 0 | 0 |
| Liquid Frac | 0 | 0 | 0 | 0 | 0 | 0 | 1 | 1 | 1 |
| Average MW | 44.00799 | 44.00799 | 44.00799 | 44.00799 | 44.00446 | 44.00799 | 18.01528 | 18.01528 | 18.02074 |

1. A process for separating CO₂ from a mixture comprising CO₂ and at least one component selected from the group consisting of hydrogen and CO, or a combination thereof, wherein the mixture has a pressure of greater than 10 bar, preferably 60 bar to 300 bar, the process comprising:
1) cooling the mixture to obtain a partially condensed stream,
2) feeding the partially condensed stream into a phase separator to produce a CO₂-depleted gas stream and a CO₂-rich liquid stream,
3) splitting the CO₂-rich liquid stream from the phase separator into at least two liquid substreams,
4) heating at least one of the liquid substreams to thereby form at least one two-phase substream, and
5) feeding the at least one two-phase substream and the remaining liquid substream(s) into a distillation column to produce a liquid comprising substantially CO₂ and an overhead vapor comprising substantially the at least one component, wherein the substream with a higher temperature is fed to a lower location of the distillation column than that of the substream with a lower temperature.

2. The process of claim 1, wherein the mixture comprises CO₂, hydrogen, CO, and small amounts of inert gas components, such as nitrogen and argon, preferably, the mixture is obtained from gasification of a carbonaceous material.

3. The process of claim 1, further comprising:
a. cooling the overhead vapor to a temperature of 15 K or less above CO₂ freeze out temperature and partially condensing the overhead vapor to form a second liquid and a vapor, and
b. feeding the second liquid to the top of the distillation column.

4. The process of claim 1, further comprising:
a. feeding at least a portion of the overhead vapor to a Dephlegmator to obtain a third liquid and a vapor, and
b. feeding at least a portion of the third liquid to the top of the distillation column.

5. The process of claim 1, wherein a single loop refrigeration system with a mixed refrigerant is used to provide at least a portion of refrigeration for the cooling of step 1), and wherein at least a portion of the liquid from the distillation column is heated, vaporized, further heated, and expanded for power generation.

6. The process of claim 1, further comprising vaporizing at two or more pressures the liquid comprising substantially CO₂ to thereby provide at least a portion of the refrigeration for the cooling of the mixture.

7. The process of claim 6 wherein the pressure of the distillation column is lower than the pressure of the CO₂-rich liquid stream coming out of the phase separator, and the liquid substream to be heated to a higher temperature is let down in pressure to a level higher than that of the distillation column before it is heated.

8. The process of claim 1, wherein at least a portion of the CO₂-depleted gas stream from the phase separator, after being heated, is expanded to a lower pressure to generate work, optionally the work provides refrigeration for the cooling of the mixture.

9. A process for separating CO₂ from a mixture comprising CO₂ and at least one component selected from a group consisting of hydrogen and CO, or a combination thereof, wherein the mixture has a pressure of greater than 10 bar, preferably 60 bar to 300 bar, the process comprising:
1) cooling the mixture by a single loop refrigeration system with a mixed refrigerant to obtain a partially condensed stream,
2) feeding the partially condensed stream into a phase separator to produce a CO₂-depleted gas stream and a CO₂-rich liquid stream, and
3) feeding the CO₂-rich liquid stream into a distillation column to produce a liquid comprising substantially CO₂ and an overhead vapor comprising substantially the at least one component.

10. The process of claim 9, wherein in step (1), the mixture is cooled by the single loop refrigeration system with the mixed refrigerant using a refrigeration process comprising:
a. compressing a vapor refrigerant comprising two or more components in a refrigerant compressor to obtain a compressed refrigerant,
b. cooling the compressed refrigerant by an external coolant to obtain a partially condensed refrigerant,
c. further cooling, condensing, and subcooling the partially condensed refrigerant in a heat exchanger to obtain a subcooled refrigerant,
d. reducing the pressure of the subcooled refrigerant to obtain a reduced pressure refrigerant,
e. heating and vaporizing the reduced pressure refrigerant in the heat exchanger of step (c) to obtain the vapor refrigerant and to provide refrigeration for the cooling of the mixture and the cooling, condensing, and subcooling of the partially condensed refrigerant, and
f. feeding the vapor refrigerant to the refrigerant compressor, thereby completing the cycle;
wherein the temperature of the reduced pressure refrigerant from step (d) is 10K or less lower than the temperature of the subcooled refrigerant from step (c).

11. The process of claim 9, wherein the mixed refrigerant comprises at least one of ethane and ethylene, and at least one of propylene, propane, butanes and butenes.

12. The process of claim 11 wherein the mixed refrigerant comprises non-C₂ components from a single source, preferably, the mixed refrigerant comprises industrial liquefied petroleum gas (LPG) or industrial butanes.

13. The process of claim 1, wherein the refrigerant compressor is a multi-stage compressor with a compression ratio in the last stage of greater than 2.

14. The process of claim 13, further comprising applying compression heat generated in the last stage of the refrigerant compressor to the CO₂-depleted gas stream and expanding the heated CO₂-depleted gas stream in an expander for power generation.

15. A process for separating CO₂ from a mixture comprising CO₂ and at least one of the components selected from a group consisting of hydrogen and CO, or a combination thereof, wherein the mixture has a pressure of greater than 10 bar, preferably 60 bar to 300 bar, the process comprising:
1) cooling the mixture to obtain a partially condensed stream,
2) feeding the partially condensed stream into a phase separator to produce a CO₂-depleted gas stream and a CO₂-rich liquid stream,
3) feeding the CO₂-rich liquid stream into a distillation column to produce an overhead vapor stream and a liquid comprising substantially CO₂,
4) heating and vaporizing the liquid comprising substantially CO₂ to obtain a heated and vaporized CO₂ gas,
5) further heating the heated and vaporized CO₂ gas to obtain a superheated CO₂ gas, and
6) expanding the superheated CO₂ in an expander for power generation.

16. The process of claim 1, wherein during off-peak electricity demand hours, at least a portion of the liquid comprising substantially CO₂ from the distillation column is stored, while during peak electricity demand hours, at least a portion of the stored and instantaneously generated liquid comprising substantially CO₂ are heated, vaporized, further heated, and expanded in an expander for power generation.

17. The process of claim 16 wherein the liquid comprising substantially CO₂ is vaporized and/or further heated by exhaust gas of a gas turbine and/or the effluent of a water-gas shift reactor.

18. The process of claim 1, further comprising applying a gas mixture to a membrane separator to obtain the mixture comprising CO₂ and the at least one component, prior to step (1), wherein the membrane separator comprises a membrane selectively permeable to hydrogen but is less permeable to CO₂.

19. The process of claim 1, wherein the mixture is obtained from gasification of a carbonaceous material, and at least a portion of the overhead vapor stream from the distillation column is heated and then mixed with the mixture obtained from the gasification of the carbonaceous material to be fed to a water-gas shift reactor to convert at least some of the CO into H₂ and CO₂ in the water-gas shift reactor, and the reactor effluent is cooled and then dried before being cooled in step (1).

20. The process of claim 1, wherein the mixture is obtained from gasification of a carbonaceous material, and at least a portion of the overhead vapor stream from the distillation column is heated and then added to the mixture to be cooled in step 1).
